(19) United States
(12) Patent Application Publication
(10) Pub. No.: US 2007/0211965 A1
(43) Pub. Date: Sep. 13, 2007

(54) Hand-held diagnostic systems and methods of use thereof

(76) Inventors: Rene P. Helbing, Palo Alto, CA (US); Annette C. Grot, Cupertino, CA (US); Julie E. Fouquet, Portola Valley, CA (US)

Correspondence Address: Kathy Manke;Avago Technologies Limited, 4380 Ziegler Road, Fort Collins, CO, 80525, US

(21) Appl. No.: 11/369,573

(22) Filed: Mar. 7, 2006

(51) Int. Cl. G06K 9/22

(52) U.S. Cl. 382/313

(57) ABSTRACT

A diagnostic system in accordance with the invention is housed in a hand-held personal communications device (PCD). The diagnostic system includes a data capture system that is used to capture diagnostic data. The diagnostic system also includes a data storage system and a processing system. The data storage system stores reference diagnostic data that is used by the processing system in conjunction with the captured diagnostic data to obtain a diagnostic result.

### DESCRIPTION OF THE RELATED ART

Improvements in device technology are typically driven by various factors such as smaller size, lower cost, and diverse functionality. Consequently, single-function devices that are bulky and expensive are eventually replaced by multi-functional devices that are smaller and cheaper. Many of these smaller devices perform multiple functions using a compact hardware platform that can be commonly shared when performing these multiple functions.

Some examples of single-function devices that are designed to provide dedicated functionality include: a video player, a digital camera, a calculator, a music player, and a conventional telephone. As is known, several of these functions are nowadays integrated into a single, compact device such as a cellular phone or a personal digital assistant (PDA).

The PDA, for example, provides a compact and versatile hardware platform that is adaptable to provide one of several available functions based on a user's requirement at any particular instance in time. For example, at a first instance of time, the PDA can be used as a telephone. In this case, the various components of the PDA are suitably configured to perform telephone functions. The display, for instance, becomes a caller-ID display, the keypad operates as a telephone keypad, and the software inside the PDA carries out call-processing functions.

At a later instance in time, the same PDA can be used as an Internet access device. Here, the display shows a web page. the keypad operates as a OQWERTY keyboard. and the software runs an Internet browser application.

The versatility of devices such as the PDA and the cellular phone, allows the integration of more and more functions into a single, low-cost unit that replaces multiple single-function devices. In light of this, it can be appreciated that a need exists to provide such integration in various areas that are not currently addressed by conventional devices.

### SUMMARY

A diagnostic system in accordance with the invention is housed in a hand-held personal communications device (PCD). The diagnostic system includes a data capture system that is used to capture diagnostic data. The diagnostic system also includes a data storage system and a processing system. The data storage system stores reference diagnostic data that is used by the processing system in conjunction with the captured diagnostic data to obtain a diagnostic result.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts throughout the several views.

FIG. 1 shows a first exemplary embodiment of a diagnostic system in accordance with the present invention.

FIG. 2 shows a second exemplary embodiment of a diagnostic system incorporating a camera and an image display in accordance with the present invention.

FIG. 3A shows a pregnancy-testing strip with a single stripe that is indicative of a negative pregnancy result.

FIG. 3B shows the pregnancy-testing strip with two stripes that are indicative of a positive pregnancy result.

FIG. 4 shows a third exemplary embodiment of a diagnostic system incorporating a camera that uses non-visible wavelengths for image capture together with a wireless transceiver in accordance with the present invention.

FIG. 5 shows a fourth exemplary embodiment of a diagnostic system incorporating an audio-tones processing system in accordance with the present invention.

FIG. 6A shows a first view of a hand-held personal communications device incorporating the diagnostic system of the present invention.

FIG. 6B shows a second view of the hand-held personal communications device of FIG. 6A.

FIG. 7 shows a flow chart of an exemplary method of diagnostics in accordance with the present invention.

### DETAILED DESCRIPTION

The various embodiments generally describe systems and methods related to a diagnostic system housed in a hand-held personal communications device (PCD).

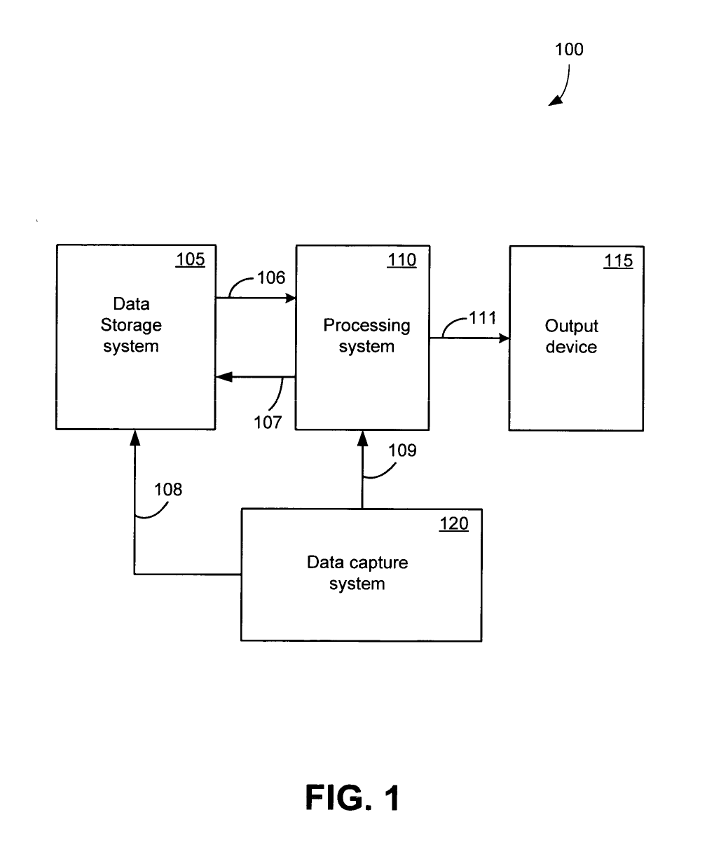

FIG. 1 shows a first exemplary embodiment of a diagnostic system 100 housed in a PCD, in accordance with the present invention. A non-exhaustive list of exemplary PCDs includes: a personal digital assistant (PDA), a conventional telephone, a cellular phone, a digital camera, and a hand-held transceiver.

Diagnostic system 100 includes a data capture system 120 communicatively coupled to processing system 110 and data storage 105. Also included is an output device 115 communicatively coupled to processing system 110. Data capture system 120 is an image capture system in one exemplary embodiment. In this exemplary embodiment, the image capture system, which is typically a digital device, is used to capture an image of an object (not shown). The digital data corresponding to the captured image is transferred via communication link 108 to data storage 105 and via communication link 109 to processing system 110 where the digital data is processed in conjunction with reference digital data.

The reference digital data is generated in various ways. In a first exemplary embodiment, the reference digital data is generated from a reference image that is captured using image capture system 120. In a second exemplary embodiment, the reference digital data is not associated with a reference image. For example, the reference digital data contains logical values such as those associated with a pass-fail test. These logical values are generated without using a reference image.

Data storage 105 is used to store the digital reference data as well as other data associated with diagnostic system 100. The digital reference data is transferred in one direction from data storage 105 to processing system 110 via communication link 106, and is transferred in the opposite direction from processing system 110 to data storage 105 via communication link 107.

It will be understood that communication links such as communication links 106, 107, 108, 109, and 111 are used to transfer digital image data as well as other digital data such as message requests and commands in various communication formats.

Operation of diagnostic system 100 will be explained in further detail using the exemplary system wherein data capture system 120 is the image capture system. In this exemplary operation, the image capture system is operated to capture a reference image of a reference object. Many different types of reference objects can be used. Some examples include: a hardcopy image, an electronic display, and a 3-dimensional object. The reference image of the reference object is used to generate reference digital data.

For example, when the reference object is a hardcopy image, the reference digital data comprises color information present in the hardcopy image. In another example, when the reference object is an electronic display, the reference digital data comprises a binary code.

The reference digital data generated from the reference image is transferred to data storage 105 via communication link 108. The image capture system is then operated to capture an image of an object from which a diagnostic result has to be obtained. The image of the object is used to generate digital data for diagnosis. This digital data is transmitted via communication link 109 to processing system 110. The reference digital data that has been previously stored in data storage 105 is provided to processing system 110 via communication link 106. Processing system 110 incorporates hardware, software, and firmware for carrying out diagnostic processing using tools such as software programs and algorithms.

Processing system 110 processes the digital data in conjunction with the reference digital data to obtain a diagnostic result. The diagnostic result is transferred to data storage 105 via communication link 107 for storage and is also provided to output device 115 via communication link 111 for presenting the diagnostic result to a user of diagnostic system 100. Some examples of output device 115 are: a display screen, a wireless transceiver, and a loudspeaker.

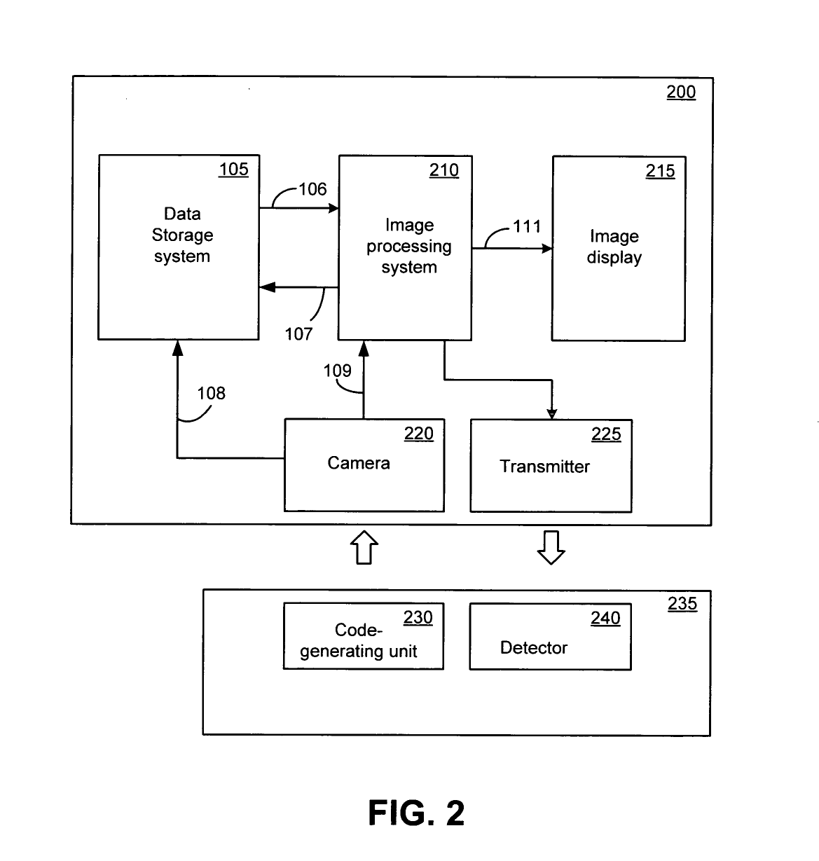

FIG. 2 shows a second exemplary embodiment of a diagnostic system 200 in which data capture system 120 is exemplified as a camera 220, and the output device is an image display 215 upon which the diagnostic result is displayed. Image display 215 is, for example, a display screen of a PDA.

Camera 220 is operated to capture the image of the object from which the diagnostic result has to be obtained. In this exemplary embodiment, the object is a code-generating unit 230 containing one or more LEDs configured to display a code, such as a binary code. Code-generating unit 230 is located on an appliance 235 such as a television set, a refrigerator, a digital meter, or a medical instrument—a blood-sugar monitoring unit, for example.

Camera 220 is used to capture an image of code-generating unit 230. The captured image is used to derive code information generated by code-generating unit 230. The code information is transferred to image processing system 210 via communication link 109.

Image processing system 210 sends a message via communication link 107 requesting reference digital data from data storage 105. The reference digital data is transmitted from data storage 105 to image processing system 210 via communication link 106. Image processing system 210 uses the reference digital data and processes the code information to obtain a diagnostic result. The diagnostic result is displayed via image display 215. Alternatively, when confidentiality is desired, the diagnostic result is not displayed on image display 215, but is instead stored in data storage 105 for later retrieval.

As mentioned above, code-generating unit 230 can be located on various appliances. Consequently, the diagnostic result pertains to the type of appliance and to the nature of the diagnosis to be performed. For example, when code-generating unit 230 is a part of a blood-sugar monitoring unit, the diagnostic result relates to blood sugar information, and the diagnostic result may indicate a dangerously low level of blood sugar in a patient using the blood-sugar monitoring unit. In this particular example, the reference digital data stored in data storage 105 is not generated using a reference image. Instead, the reference digital data provides information that relates various blood sugar levels to the effects of these blood sugar levels upon the patient.

Attention is now drawn to transmitter 225 which is used to transmit information from diagnostic system 200 to appliance 235. In an exemplary embodiment, transmitter 225 contains an LED which transmits digital data by producing a sequence of light flashes. The sequence of light flashes, which is used to provide communication information such as control signals and messages, is detected by an optical detector 240 located in appliance 235. For example, a first sequence of flashes is used to transmit a command from diagnostic system 200 to appliance 235 whereby a certain quantity of insulin is injected into the patient by the appliance 235.

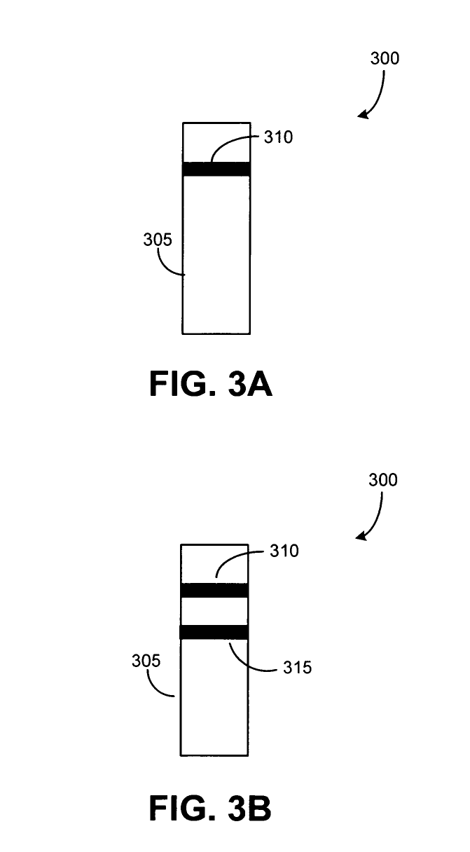

While FIG. 2 shows an exemplary embodiment in which camera 220 is operated to capture code from a code-generating unit 230; in an alternative embodiment, camera 220 is used to capture information from a pregnancy-testing strip 300. Two different images of pregnancy-testing strip 300 are shown in FIGS. 3A and 3B.

In FIG. 3A pregnancy-testing strip 300 contains a single stripe 310. Camera 220 is operated to capture an image of pregnancy-testing strip 300 of FIG. 3A. The image information derived from the captured image includes the information that only a single stripe 310 is present in the image. This image information is provided to image processing system 210 via communication link 109.

Image processing system 210 sends a message via communication link 107 requesting reference digital data from data storage 105. The reference digital data is transmitted from data storage 105 to image processing system 210 via communication link 106. Image processing system 210 uses the reference digital data and processes the single-stripe image information to obtain a diagnostic result. The reference digital data stored in data storage 105 provides the information that the presence of a single stripe is indicative of a negative pregnancy test. Consequently, image processing system 210 produces a diagnostic result indicating a negative pregnancy.

The diagnostic result is displayed via image display 215. Alternatively, when confidentiality is desired, the diagnostic result is not displayed on image display 215, but is instead stored in data storage 105 for later retrieval.

When camera 220 of diagnostic system 200 is used to capture an image of pregnancy-testing strip 300 shown in FIG. 3B, a second stripe 315 is present in addition to the stripe 310. The reference digital data obtained from data storage 105 provides the information that the presence of two stripes is indicative of a positive pregnancy test. Image processing system 210 processes the captured image of pregnancy-testing strip 300 of FIG. 3B together with the reference digital data and derives a diagnostic result indicating a positive pregnancy. Again, the diagnostic result may be stored in data storage 105, displayed via image display 215, or simultaneously stored and displayed.

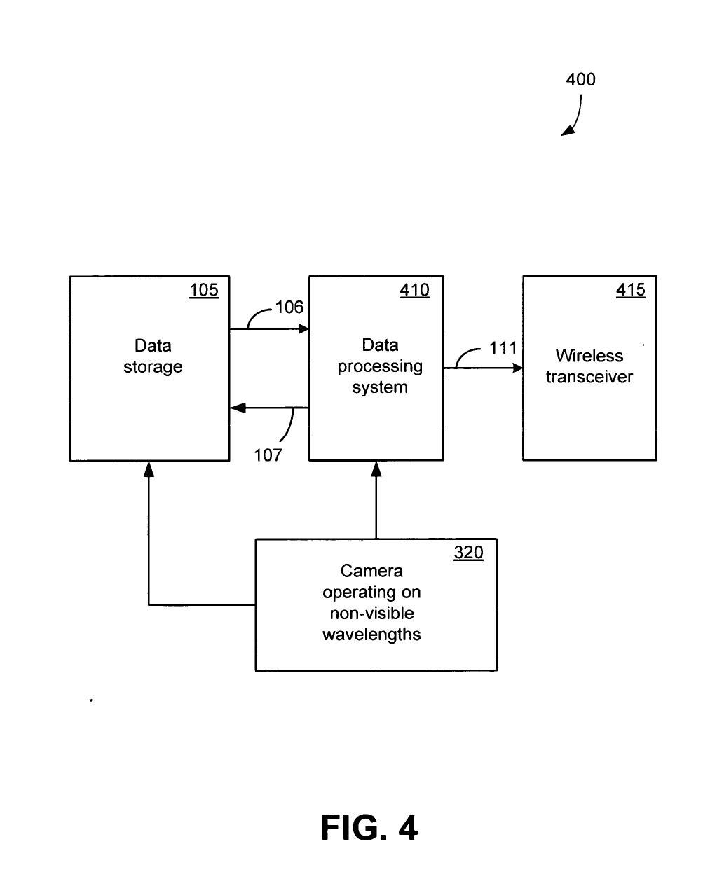

FIG. 4 shows a third exemplary embodiment of a diagnostic system 400 in which the image capture system is a camera 320 operating on non-visible wavelengths, and the output device is a wireless transceiver 415. Diagnostic system 400 provides confidentiality in obtaining and transmitting certain information. In one exemplary embodiment, camera 320 is an ultraviolet (UV) camera or an infra-red (IR) camera, and the object for diagnosis, which is a drug-testing strip (not shown), contains information that is not visible to the human eye.

Data processing system 410 receives digital data from the captured image of the drug-testing strip and provides the diagnostic result to wireless transceiver 415.

Wireless transceiver 415 transmits the drug-testing related diagnostic result to a remote receiver (not shown) thereby providing confidentiality because the user of diagnostic system 400 is unable to readily obtain the diagnostic result. In an exemplary embodiment, diagnostic system 400 is incorporated into a conventional cellular phone and wireless transceiver 415 is the transceiver built into the cellular phone. The diagnostic result is transmitted over a cellular network to a receiver, which may be another cellular phone, a conventional telephone, or a communications device such as a personal computer (PC).

When the user of diagnostic system 400 desires to view the diagnostic result, and is permitted to do so, the diagnostic result is displayed on a display screen (not shown) of diagnostic system 400. In this case, diagnostic system 500 is operative to translate the information in the drug-testing strip that is invisible to the human eye into visible information that can be viewed on the display screen.

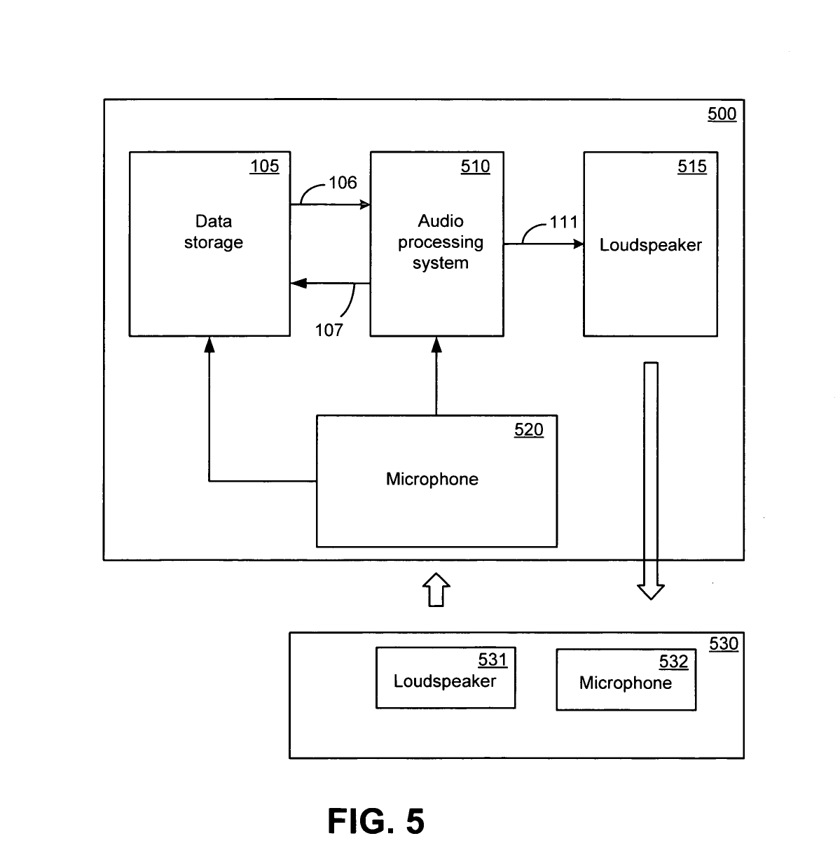

FIG. 5 shows a fourth exemplary embodiment of a diagnostic system 500 in which the output device is a loudspeaker 515 and the input device is a microphone 520. Diagnostic system 500 is an acoustical diagnostic system housed in a PCD. Appliance 530, which is, for example, an acoustical modem or a medical instrument, contains a loudspeaker 531 and a microphone 532.

In a first exemplary embodiment, appliance 530 is a heart-rate monitor. Heart-rate sounds produced via loudspeaker 531 are acoustically coupled into microphone 520. Microphone 520 converts the sounds into electrical signals that are provided to audio-processing system 510.

Audio-processing system 510 digitizes the electrical signals and processes the digitized signals together with diagnostic information obtained from data storage 105. The diagnostic information includes, for example, analysis information relating to diagnosing a healthy versus an unhealthy heart. In one exemplary embodiment, the diagnostic result obtained after processing in audio-processing system 510, is stored in data storage 105 for retrieval later. In another embodiment, the diagnostic result is transmitted out of diagnostic system 500 via a wireless transceiver (not shown).

In a second exemplary embodiment, appliance 530 is an acoustical modem. Speaker 531 produces audio tones corresponding to modem tones. The audio tones are acoustically coupled into microphone 520, which converts the audio tones into electrical signals that are provided to audio-processing system 510. Audio-processing system 510 decodes the electrical signals together with data obtained from data storage 105. In an exemplary embodiment, the decoded diagnostic result is stored in data storage 105, while in another exemplary embodiment the diagnostic result is transmitted out of diagnostic system 500 via a wireless transceiver.

Appliance 530 utilizes microphone 532 to receive audio tones transmitted by loudspeaker 515 of diagnostic system 500. The received audio tones are decoded in appliance 530 as modem tones. Loudspeaker 515 and microphone 532 facilitate flow of modem information in one direction, while loudspeaker 531 and microphone 520 facilitate flow of modem information in the opposite direction. Consequently, in this exemplary embodiment, diagnostic system 500 and appliance 530 constitute a bi-directional modem system.

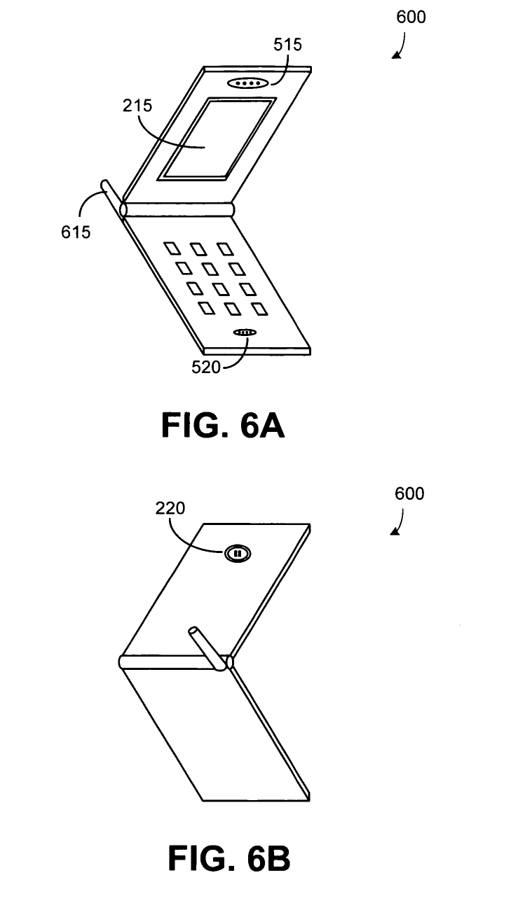

FIGS. 6A and 6B show two views of an exemplary PCD 600 housing one or more diagnostic systems such as the systems described above. FIG. 6A shows PCD 600 containing a microphone 520, a loudspeaker 515, an image display 215, and an antenna 615, which is part of a wireless transceiver. These elements have been described above in connection with various exemplary systems. FIG. 6B show PCD 600 containing a camera 220, which is used for capturing an image.

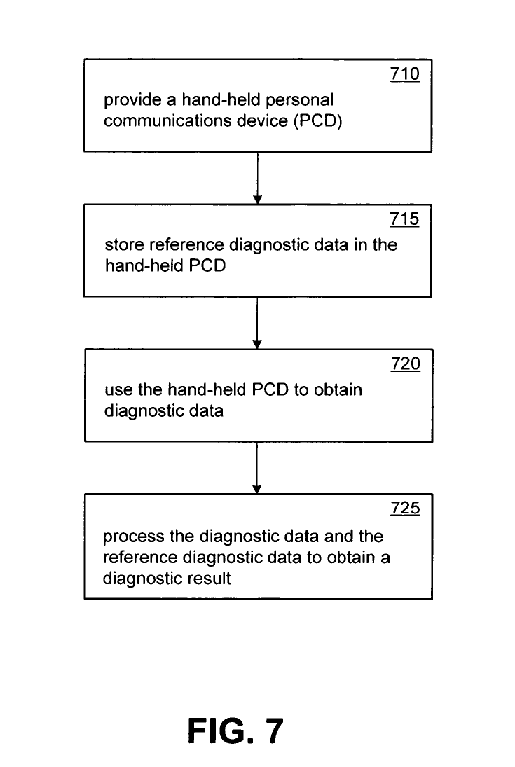

FIG. 7 shows a flowchart for an exemplary method of diagnostics. In block 710, a hand-held PCD is provided. In block 715, reference diagnostic data is stored in the hand-held PCD. Storing reference diagnostic data incorporates one or more actions such as capturing an image using a digital camera, storing digital information in a data storage device, or transmitting data via an acoustical coupling system. In block 720, the hand-held PCD is used to obtain diagnostic data. The processes used to obtain the diagnostic data may include in part, certain procedures used for storing reference diagnostic data. In block 725, the diagnostic data is processed together with the reference diagnostic data to obtain a diagnostic result.

The above-described embodiments are merely set forth for a clear understanding of the principles of the disclosure. Many variations and modifications may be made without departing substantially from the disclosure. All such modifications and variations are included herein within the scope of this disclosure.

We claim:

1. A method for using a hand-held personal communications device (PCD) for diagnosis, the method comprising:
providing the hand-held PCD;
storing reference diagnostic data in the hand-held PCD;
using the hand-held PCD to obtain diagnostic data; and
processing the diagnostic data and the reference diagnostic data to obtain a diagnostic result.

2. The method of claim 1, wherein the hand-held PCD is one of a) a telephone, b) a cellular phone, c) a personal digital assistant (PDA), and d) a digital camera.

3. The method of claim 2, wherein:
storing reference diagnostic data comprises receiving in the PCD, reference diagnostic data from a communications device located external to the PCD.

4. The method of claim 3, wherein the communications device is one of a) a telephone, b) a cellular phone, and c) a computer.

5. The method of claim 2, wherein:
storing reference diagnostic data comprises using the hand-held PCD to capture a diagnostic image.

6. The method of claim 1, wherein:
using the hand-held PCD to obtain diagnostic data comprises capturing a first image of an object; and
processing the diagnostic data and the reference diagnostic data comprises processing the first image of the object and the reference diagnostic data to obtain a diagnostic result.

7. The method of claim 6, further comprising:
transmitting the diagnostic result to a remote recipient through a wireless communications network.

8. The method of claim 7, wherein:
the hand-held PCD is a first cellular phone; and
the diagnostic result is transmitted to a remote recipient through a cellular communications network.

9. The method of claim 8, wherein:
the diagnostic result is received by the remote recipient on one of a) a second cellular phone, b) a telephone, c) a communications device, and d) a computer.

10. The method of claim 6, wherein:
the object is a testing strip; and
processing the first image of the object comprises identifying the presence of a first stripe in the testing strip.

11. The method of claim 10, wherein:
processing the first image of the object further comprises identifying the presence of a second stripe in the testing strip.

12. The method of claim 1, wherein:
the hand-held PCD is a first cellular phone; and
the diagnostic result is displayed on a display screen of the first cellular phone.

13. A diagnostic system housed in a hand-held personal communications device (PCD), the system comprising:
a data capture system configured to capture diagnostic data;
a data storage system configured in part to store reference diagnostic data; and
a processing system configured in part to process captured diagnostic data and the reference diagnostic data to obtain a diagnostic result.

14. The diagnostic system of claim 13, wherein:
the hand-held PCD is one of a) a telephone, b) a cellular phone, c) a personal digital assistant (PDA), and d) a camera.

15. The diagnostic system of claim 14, further comprising:
an output device configured to provide the diagnostic result to one of a) a user of the PCD and b) a remote recipient.

16. The diagnostic system of claim 15, wherein:
the output device is one of a) a display screen of the PCD and b) a wireless transceiver of the PCD.

17. The diagnostic system of claim 14, wherein the data capture system comprises an image capture system configured to capture an image of an object.

18. The diagnostic system of claim 17, wherein:
the image capture system comprises one of a) a camera configured to capture the image using visible light and b) an camera configured to capture the image using infra-red light.

19. The diagnostic system of claim 18, wherein:
the object changes state from a first state to a second state, the first state being captured as part of the reference diagnostic data and the second state being captured as a part of the diagnostic data.

20. The diagnostic system of claim 19, wherein:
the object is a testing strip; and
the first state comprises a first stripe present on the testing strip.

21. The diagnostic system of claim 19, wherein:
the object is a testing strip;
the first state comprises a first stripe present on the testing strip; and
the second state comprises a second stripe present on the testing strip.

22. The diagnostic system of claim 13, further comprising:
an output device comprising at least one of a) a display screen, b) an audio synthesizer, c) a wired communication link, d) a wireless communication link, and e) an optical communication link.

23. A diagnostic system comprising:
a microphone housed in a hand-held personal communications device (PCD), the microphone operable to receive a first audio tone;
a data storage system housed in the PCD, the data storage system operable to storing reference diagnostic data;
an audio-processing system housed in the PCD, the audio-processing system operable to process the first audio tone and the reference diagnostic data to obtain a diagnostic result.

24. The system of claim 23, wherein the PCD is one of a) a cellular phone, b) a personal digital assistant (PDA), and c) a digital camera.

25. The system of claim 24, wherein the first audio tone is a modem tone and the PCD is operable as a modem.
